(19) United States
(12) Patent Application Publication
(10) Pub. No.: US 2013/0240306 A1
(43) Pub. Date: Sep. 19, 2013

(54) BRAKE SHIMS AND METHODS OF FORMING SAME

(71) Applicants: Matt Murphy, Birmingham, MI (US); Hong Xiao, Farmington Hills, MI (US)

(72) Inventors: Matt Murphy, Birmingham, MI (US); Hong Xiao, Farmington Hills, MI (US)

(73) Assignee: MATERIAL SCIENCES CORPORATION, Elk Grove Village, IL (US)

(21) Appl. No.: 13/422,007

(22) Filed: Mar. 16, 2012

(51) Int. Cl. F16D 65/097; B21D 53/88; B21D 22/00

(52) U.S. Cl. 188/73.37; 72/46

(57) ABSTRACT

A brake shim includes a metal substrate having a first surface and a second surface spaced opposite the first surface. The brake shim includes a first film formed from a viscoelastic material and disposed on the first and second surfaces, wherein the first film has a first elastic modulus, a primary surface spaced opposite the first surface, and a secondary surface spaced opposite the primary surface. The brake shim includes a second film formed from a polymer composition including a resin component having at least one epoxide functional group and a curing agent reactive with the resin component and having at least one amine functional group. The second film is disposed on the primary and secondary surfaces and has a second elastic modulus that is from about 10 times to about 1,000 times greater than the first elastic modulus. A method of forming the brake shim is also disclosed.

### TECHNICAL FIELD

The present disclosure generally relates to brake shims and methods of forming brake shims.

### BACKGROUND

Brake shims diminish noise, vibration, and harshness generated during vehicle braking, and may dissipate energy by mechanisms such as material damping, isolation, and/or frictional damping. For example, brake shims may dissipate vibrational energy via constrained-layer damping wherein a viscoelastic material is sandwiched between two metal layers.

### SUMMARY

A brake shim includes a metal substrate having a first surface and a second surface spaced opposite the first surface. The brake shim also includes a first film formed from a viscoelastic material and disposed on the first surface and the second surface, wherein the first film has a first elastic modulus, a primary surface spaced opposite the first surface, and a secondary surface spaced opposite the primary surface. In addition, the brake shim includes a second film formed from a polymer composition including a resin component and a curing agent reactive with the resin component. The resin component has at least one epoxide functional group, and the curing agent has at least one amine functional group. The second film is disposed on the primary surface and the secondary surface and has a second elastic modulus that is from about 10 times to about 1,000 times greater than the first elastic modulus.

In one embodiment, the metal substrate has a thickness of from about 0.25 mm to about 0.75 mm. Further, the first film is formed from a nitrile butadiene rubber. In addition, the first film is compressible and has a first thickness of from about 0.025 mm to about 0.10 mm. Further, the second film is formed from an epoxy coating composition, and has an engagement surface spaced opposite the primary surface and an attachment surface spaced opposite the engagement surface. The second film has a second thickness of from about 0.025 mm to about 0.075 mm.

A method of forming a brake shim includes applying a viscoelastic material to a metal substrate, wherein the metal substrate has a first surface and a second surface spaced opposite the first surface. After applying the viscoelastic material, the method includes at least partially curing the viscoelastic material to form a first film disposed on the first surface and the second surface. The first film has a first elastic modulus, a primary surface spaced opposite the first surface, and a secondary surface spaced opposite the primary surface. The method further includes applying a polymer composition to the first film, and, after applying the polymer composition, curing the polymer composition to form a second film disposed on the primary surface and the secondary surface and having a second elastic modulus that is from about 10 times to about 1,000 times greater than the first elastic modulus to thereby form a composite material. The polymer composition includes a resin component having at least one epoxide functional group, and a curing agent reactive with the resin component and having at least one amine functional group. The method further includes stamping the composite material to thereby form the brake shim.

The detailed description and the drawings or Figures are supportive and descriptive of the disclosure, but the scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic exploded illustration of a perspective view of a brake shim attached to a backing plate;

FIG. 2 is a schematic illustration of a cross-sectional view of the brake shim of FIG. 1 taken along section line 2-2; and

FIG. 3 is a schematic illustration of a method of forming the brake shim of FIGS. 1 and 2.

### DETAILED DESCRIPTION

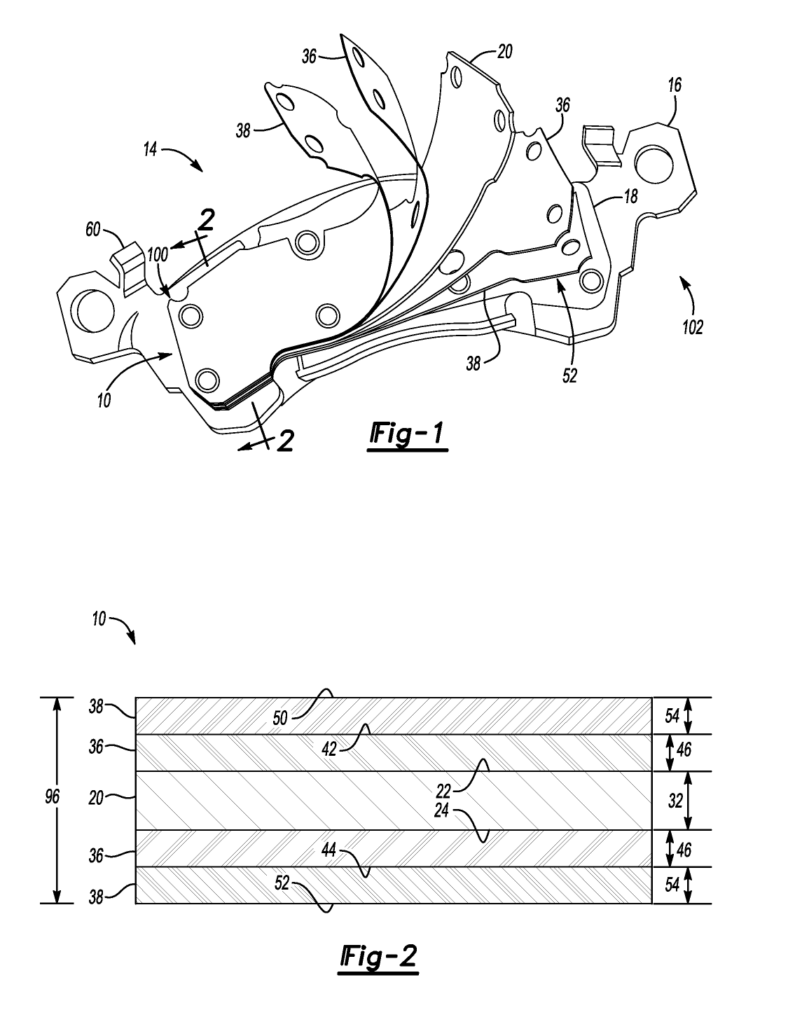

Referring to the Figures, wherein like reference numerals refer to like elements, a brake shim is shown generally at 10 in FIG. 1, and a method of forming the brake shim 10 is shown generally at 12 in FIG. 3. The brake shim 10 or brake insulator may be useful for a brake assembly of a vehicle (not shown), and may, for example be a component of a brake pad (not shown). However, the brake shim 10 and method 12 may also be useful for non-vehicular applications requiring excellent noise, vibration, and harshness dissipation and/or damping characteristics.

Referring again to FIG. 1, the brake shim 10 described herein may be formed from a composite material 14, and may be attached to a backing plate 16 during use. By way of one non-limiting example, an adhesive 18 may be sandwiched between the brake shim 10 and the backing plate 16 to thereby attach the brake shim 10 to the backing plate 16. However, the brake shim 10 may be fixedly attached to the backing plate 16 by any suitable method or material. For example, the brake shim 10 may be mechanically joined to the backing plate 16 via a clip or bracket.

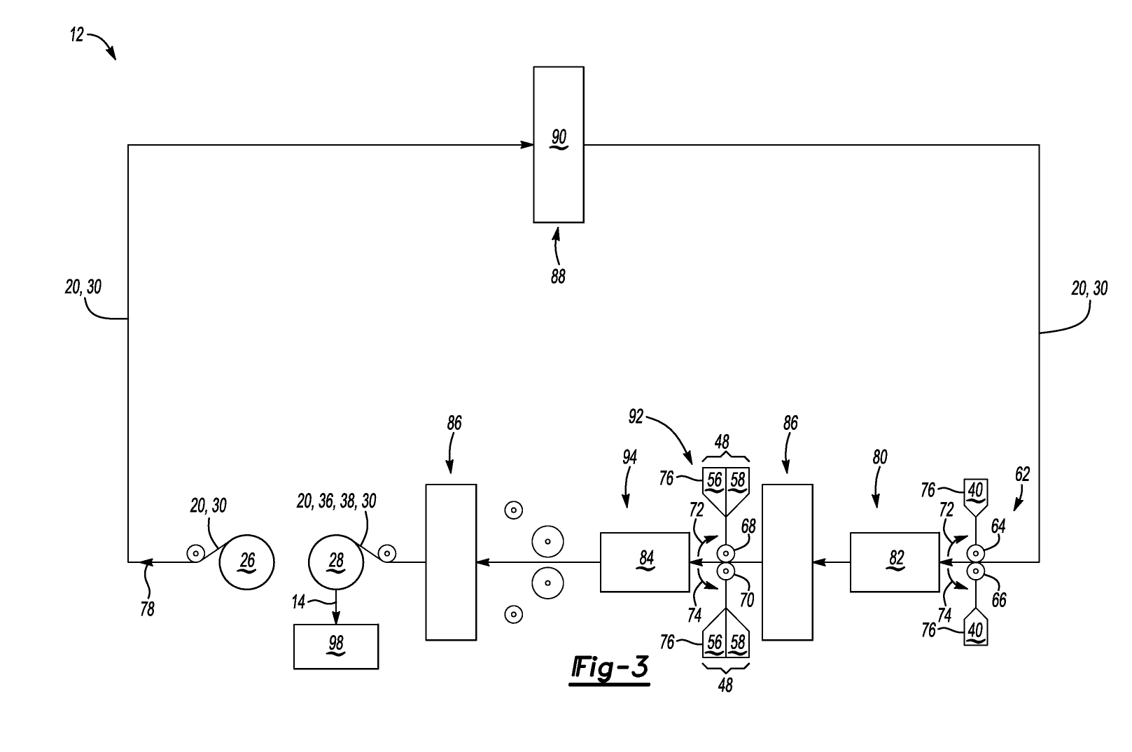

Referring now to FIGS. 1 and 2, the brake shim 10 includes a metal substrate 20 having a first surface 22 (FIG. 2) and a second surface 24 (FIG. 2) spaced opposite the first surface 22. The metal substrate 20 may be selected according to the desired operating conditions of the brake shim 10, and may, for example, provide strength, stiffness, and/or support to the brake shim 10. The metal substrate 20 may be formed from any suitable metal, such as, but not limited to, aluminum, steel, e.g., cold rolled steel, galvanized steel, and stainless steel, and combinations of aluminum and steel. Further, the brake shim 10 may include only one metal substrate 20. That is, the brake shim 10 may not include two or more metal substrates 20.

Referring to FIG. 3, in one non-limiting embodiment of the method 12, as set forth in more detail below, the metal substrate 20 may be provided in the form of a payoff coil or roll (illustrated generally at 26 in FIG. 3), but may be coated and processed as a sheet (denoted generally at 30 in FIG. 3) having a thickness 32 (FIG. 2) of from about 0.25 mm to about 0.75 mm, e.g., from about 0.4 mm to about 0.6 mm. However, the metal substrate 20 may be rolled upon itself into the payoff coil or roll 26 that is suitable for unrolling, processing, and re-rolling. In addition, although not shown, the payoff coil or roll 26 of metal substrate 20 may include an interleaf between each successive layer of the payoff coil or roll 26. Alternatively, for other non-limiting embodiments of the method 12, the metal substrate 20 may not be provided in the form of the payoff coil or roll 26 but may rather be provided, for example, in sheet form 30 or in the form of shaped workpieces (not shown).

In addition, although not shown, it is to be appreciated that the metal substrate 20 may include a primer layer formed from a primer composition. In such embodiments, the primer layer may be disposed on the metal substrate 20 and thereby form the first surface 22 (FIG. 2) and the second surface 24 (FIG. 2). In particular, the primer composition may be selected to coat and protect the metal substrate 20. In addition, the primer composition may chemically and/or physically prepare the metal substrate 20 to accept an additional film 36 (FIGS. 1 and 2) or layer, as set forth in more detail below. For example, the primer composition may be selected to bond with a viscoelastic material 40 (FIG. 3). Although optional, a suitable example of a primer composition is a phenolic resin, which may be commercially available under the trade name Chemlok® 205 from Lord Corporation of Cary, N.C.

Referring again to FIGS. 1 and 2, the brake shim 10 also includes a first film 36 formed from the viscoelastic material 40 (FIG. 3) and disposed on the first surface 22 (FIG. 2) and the second surface 24 (FIG. 2). The first film 36 has a primary surface 42 spaced opposite the first surface 22 and a secondary surface 44 spaced opposite the primary surface 42. Further, the first film 36 has a first thickness 46 of from about 0.025 mm to about 0.10 mm. For example, the first thickness 46 may be from about 0.05 mm to about 0.8 mm. As used herein, the terminology “thickness” refers to a depth of a film (e.g., the first film 36) after the film has cured, set, dried, cross-linked, and/or hardened. In addition, the first film 36 may be compressible and may be generally characterized as elastic.

Further, the primary surface 42 and the secondary surface 44 may not be tacky. As used herein, the terminology “tacky” refers to a material that retains a sticky feel to the touch. That is, a tacky material may not be fully cured or dried, or may be inherently sticky based upon its chemical constituents, and as such, exhibits a gummy and/or gluey surface, appearance, and/or characteristic. As such, the first film 36 may not be a mastic, and may therefore be applied to the metal substrate 20 with conventional coil coating equipment (illustrated generally in FIG. 3 and set forth in more detail below). That is, since the primary and secondary surfaces 42, 44 may not be tacky or sticky, conventional coil coating equipment does not require modification in order to dispose the viscoelastic material 40 on the metal substrate 20.

In addition, the first film 36 has a first elastic modulus. As used herein the terminology “elastic modulus” may refer to a Young's modulus or a shear modulus. Further, the first film 36 may have a hardness of from about 40 Shore A to about 90 Shore A.

Without intending to be limited by theory, the viscoelastic material 40 (FIG. 3) may impart excellent damping and isolation properties to the brake shim 10 (FIG. 2). For example, the viscoelastic material 40 may be selected as an isolation material to minimize transmission of vibration to the metal substrate 20 (FIG. 2) during, for example, vehicle braking operations, as set forth in more detail below. As such, the first film 36 (FIG. 2) may assist in isolating the metal substrate 20 from a source of vibrational energy, e.g., a brake pad (not shown) that is engaged with a rotor (not shown) of a vehicle (not shown). Such damping may occur as a result of extension and compression of the first film 36 formed from the viscoelastic material 40 during vehicle braking operations and/or from micro-shearing of the first film 36.

In one non-limiting embodiment, the viscoelastic material 40 may be a rubber. Suitable rubbers include, but are not limited to, natural rubbers, neoprene rubbers, isoprene rubbers, butadiene rubbers, styrene-butadiene rubbers, nitrile butadiene rubbers, urethane rubbers, silicone rubbers, fluorine rubbers, halogenated rubbers, butyl rubbers, and combinations thereof. In one non-limiting example, the viscoelastic material 40 may include a nitrile butadiene rubber (NBR). That is, the first film 36 (FIG. 2) may be formed from a nitrile butadiene rubber. A suitable example of a viscoelastic material 40 is commercially available under the trade name MSC S5 from Material Sciences Corporation of Elk Grove Village, Ill.

In addition, referring again to FIG. 2, the brake shim 10 includes a second film 38 formed from a polymer composition 48 (FIG. 3) and disposed on the primary surface 42 and the secondary surface 44. In one embodiment, the second film 38 has an engagement surface 50 spaced opposite the primary surface 42 and an attachment surface 52 spaced opposite the engagement surface 50. Further, the second film 38 may have a second thickness 54 (FIG. 2) of greater than about 0.015 mm. As a non-limiting example, the second thickness 54 may be from about 0.025 mm to about 0.075 mm. That is, the second thickness 54 may be less than 1 mm, e.g., from about 0.04 mm to about 0.06 mm.

In addition, as described with continued reference to FIG. 2, the second film 38 has a second elastic modulus that is from about 10 times to about 1,000 times greater than the first elastic modulus. For example, the second elastic modulus of the second film 38 may be from about 100 times to about 1,000 times greater than the first elastic modulus of the first film 36. As such, the second film 38 exhibits excellent stiffness and rigidity. Stated differently, the first elastic modulus of the first film 36 may be less than the second elastic modulus of the second film 38. Therefore, the second film 38 may be substantially stiffer and less elastic than the first film 36. As such, the viscoelastic material 40 may micro-shear upon exposure to vibrational energy, and the second film 38 may function as a constraining layer for the brake shim 10, as set forth in more detail below.

As described with reference to FIG. 3, the polymer composition 48 includes a resin component (represented generally at 56) having at least one epoxide functional group. As used herein, the terminology “epoxide functional group” refers to a cyclic ether having three ring atoms. The resin component 56 may include more than one epoxide functional group and may be characterized as a polyepoxide resin or an epoxy resin.

In addition, the polymer composition 48 includes a curing agent (represented generally at 58 in FIG. 3) reactive with the resin component 56 and having at least one amine functional group. As used herein, the terminology “amine functional group” refers to a functional group having a nitrogen atom and a lone pair of electrons. The curing agent 58 may include more than one amine functional group and may be characterized as a polyamine. The curing agent 58 may react with the resin component 56 to harden the polymer composition 48 and form the second film 38 (FIG. 2), as set forth in more detail below. In particular, the at least one epoxide functional group may react with the at least one amine functional group to form a covalent bond. As such, upon cure, the polymer composition 48 may harden to form a cross-linked polymer, i.e., the second film 38, wherein the cross-linked polymer may have a matrix or lattice structure (not shown).

The polymer composition 48 may further include a rubber component (not shown). More specifically, the rubber component may be embeddable within the cross-linked matrix or lattice structure (not shown) of the cured second film 38 (FIG. 2) formed from the polymer composition 48. The rubber component may be the same or different than the viscoelastic material 40 (FIG. 3). Without intending to be limited by theory, the rubber component may complement the first film 36 (FIG. 2) formed from the viscoelastic material 40 and may provide the brake shim 10 (FIG. 2) with excellent damping and isolation properties. Suitable rubber components may include, but are not limited to, natural rubbers, neoprene rubbers, isoprene rubbers, butadiene rubbers, styrene-butadiene rubbers, nitrile butadiene rubbers, urethane rubbers, silicone rubbers, fluorine rubbers, halogenated rubbers, butyl rubbers, and combinations thereof.

Alternatively or additionally, the polymer composition 48 may further include an additive component (not shown). The additive component may be selected to impart texture, decrease surface area, and/or lower a coefficient of friction of the second film 38 (FIG. 2) formed from the cured polymer composition 48. Suitable additive components may include, but are not limited to, inorganic and/or organic fillers such as glass beads, e.g., hollow glass microspheres; fibers, e.g., carbon fibers; silicas; clays; and combinations thereof

The polymer composition 48 may be selected to provide the brake shim 10 (FIGS. 1 and 2) with excellent stiffness and rigidity. That is, the polymer composition 48 may complement the viscoelastic material 40 (FIG. 3) so that the brake shim 10 provides both isolation and shear damping characteristics, as set forth in more detail below. For example, the polymer composition 48 may be selected so that the brake shim 10 includes a coated constraining layer (i.e., the second film 38 (FIG. 2)), as opposed to a metal constraining layer. That is, the polymer composition 48 may be selected so that the brake shim 10 does not include two or more metal substrates 20, e.g., a second metal substrate (not shown) spaced apart from the metal substrate 20. Rather, the polymer composition 48 may exhibit excellent stiffness and rigidity when cured, and may function as the second metal substrate (not shown). Therefore, the second film 38 may eliminate a requirement for the brake shim 10 to include more than one metal substrate 20.

In one non-limiting embodiment, the polymer composition 48 may be an epoxy coating composition. That is, for this embodiment, the second film 38 is formed from an epoxy coating composition. A suitable example of a polymer composition 48 is commercially available under the trade name RC-1 from Material Sciences Corporation of Elk Grove Village, Ill.

Further, although not shown, it is to be appreciated that the brake shim 10 (FIG. 2) may optionally include one or more additional layers, such as, but not limited to, an anti-friction layer (not shown) formed from an anti-friction coating composition. The anti-friction coating composition may be selected to ensure that the composite material 14 (FIG. 3) has a low coefficient of friction for ease of processing. The anti-friction coating composition may also be selected to minimize noise during vehicle braking That is, the anti-friction coating composition may be characterized as a low-friction coating composition, such as graphite or polytetrafluoroethylene. Suitable examples of anti-friction coating compositions include graphite, commercially available from Whitford Corporation of Elverson, Pa.

Referring again to FIG. 1, in operation, the brake shim 10 may be attached to the backing plate 16, which may be configured for use with a vehicle braking system (not shown), and may be formed from, for example, a metal and/or composite. The backing plate 16 may have any shape and size according to a desired function of the vehicle braking system (not shown). For example, the backing plate 16 may have a curved shape and may include one or more attachment elements 60 configured for attachment to a brake pad (not shown).

In addition, with continued reference to FIG. 1, the brake shim 10 may be attached to the backing plate 16 with, for example, the adhesive 18. More specifically, the adhesive 18 may be applied to the attachment surface 52 of the brake shim 10 so that the brake shim 10 may join to the backing plate 16. That is, in one non-limiting embodiment, the adhesive 18 may be sandwiched between the brake shim 10 and the backing plate 16 so that the adhesive 18 contacts the attachment surface 52 and the backing plate 16. The adhesive 18 may be any suitable adhesive for attaching the brake shim 10 to the backing plate 16. For example, the adhesive 18 may be a pressure-sensitive adhesive.

Referring now to FIG. 3, the method 12 of forming the brake shim 10 (FIG. 1) is disclosed. As set forth in more detail below, the method 12 is cost-effective and forms the brake shim 10 having excellent isolation and damping characteristics. Further, conventional coil coating equipment (illustrated generally in FIG. 3) does not require modification for the method 12, as also set forth in more detail below.

Referring to FIG. 3, the method 12 includes applying 62 the viscoelastic material 40 to the metal substrate 20. For the method, the viscoelastic material 40 may be applied to the metal substrate 20 via any suitable process. By way of non-limiting examples, the viscoelastic material 40 may be applied to the metal substrate 20 via rollers 64, 66, 68, 70 (FIG. 3), knives (not shown), laminators (not shown), sprayers (not shown), extruders (not shown), and combinations thereof. Further, in one example, the viscoelastic material 40 may be applied in non-liquid or film form. In another example, the viscoelastic material 40 may be applied in liquid form.

In one non-limiting embodiment, the viscoelastic material 40 may be applied to the metal substrate 20 as part of a continuous coil coating process. That is, as used herein, the terminology “coil coating process” refers to a continuous, automated metal coating operation that applies one or more compositions to the metal substrate 20 via, for example, one or more rollers 64, 66, 68, 70 (FIG. 3) to form layers or films 36, 38 (FIG. 2) disposed on the metal substrate 20. Coil coating processes do not include processing the metal substrate 20 in a non-continuous operation. Rather, for this embodiment of the method 12, the metal substrate 20 may be coated continuously by rolling a material onto the metal substrate 20, as set forth in more detail below.

For purposes of illustration, FIG. 3 is a schematic representation of an exemplary continuous coil coating process. The continuous coil coating process may include one or more passes, and the metal substrate 20 may travel through the operations of the continuous coil coating process at one or more line speeds.

Therefore, with continued reference to FIG. 3, applying 62 the viscoelastic material 40 may include transferring the viscoelastic material 40 in liquid form from at least a first roller 64 to the first surface 22 (FIG. 2), and from at least a second roller 66 to the second surface 24 (FIG. 2) wherein the at least first roller 64 is rotatable in a first direction (denoted by arrow 72) and the at least second roller 66 is rotatable in a second direction (denoted by arrow 74) that is opposite the first direction 72. It is to be appreciated that the at least first roller 64 and the at least second roller 66 may each include a plurality of rollers (not shown), and may each be configured as, for example, a three-roller reverse coating apparatus or system. That is, as shown generally in FIG. 3, the metal substrate 20 may be supplied as the payoff coil or roll 26 and may be unwound for processing in sheet form (represented generally by 30). The viscoelastic material 40 may be transferred at a wet film thickness (not shown) of from about 0.03 mm to about 0.5 mm, e.g., about 0.25 mm. As used herein, the terminology “wet film thickness” refers to a thickness or depth of a composition (e.g., the viscoelastic material 40) as applied in the form of a solution or a dispersion before a carrier (e.g., a solvent or water) of the composition is evaporated.

The viscoelastic material 40 may be supplied to the at least first roller 64 and the at least second roller 66 via, for example, one or more storage vessels 76 disposed in fluid communication with each of the at least first and second rollers 64, 66. For example, each of the at least first and second rollers 64, 66 may pick up the viscoelastic material 40, rotate in opposite directions 72, 74, and roll the viscoelastic material 40 onto the metal substrate 20 as the metal substrate 20 continuously travels or advances in the processing direction (represented generally by arrow 78 in FIG. 3). That is, in this embodiment, the viscoelastic material 40 may not be applied to the metal substrate 20 via extrusion and/or a calendered film laminating process. Therefore, in this embodiment, the viscoelastic material 40 may be applied via the at least first and second rollers 64, 66 to achieve a comparatively higher first thickness 46 (FIG. 2) than would be possible if the viscoelastic material 40 were applied via solution coating.

With continued reference to FIG. 3, after applying 62 the viscoelastic material 40, the method 12 includes at least partially curing 80 the viscoelastic material 40 to form the first film 36 (FIG. 2). As best shown in FIG. 2, the resulting first film 36 is disposed on the first surface 22 and the second surface 24. That is, the first film 36 is disposed on both “sides” of the metal substrate 20, i.e., the “top” surface (e.g., the first surface 22) and the “bottom” surface (e.g., the second surface 24) of the metal substrate 20. Therefore, the resulting first film 36 has the primary surface 42 spaced opposite the first surface 22, and the secondary surface 44 spaced opposite the primary surface 42.

Referring again to FIG. 3, at least partially curing 80 the viscoelastic material 40 may include increasing a temperature of the viscoelastic material 40 from about 100° C. to about 260° C. for from about 1 minute to about 5 minutes. More specifically, at least partially curing 80 the viscoelastic material 40 may include first baking the viscoelastic material 40 in a first oven 82, and subsequently baking the viscoelastic material 40 again. For at least partially curing 80 the viscoelastic material 40 to form the first film 36, the first oven 82 may have a plurality of heating zones (not shown), e.g., three or four heating zones, configured to sequentially heat the metal substrate 20 and the viscoelastic material 40.

As such, at least partially curing 80 the viscoelastic material 40 may form the first film 36 (FIG. 2) such that the primary surface 42 (FIG. 2) and the secondary surface 44 (FIG. 2) are not tacky. That is, the first film 36 may not gum up or adversely stick to the first and second rollers 64, 66, and may not be a mastic. Further, at least partially curing 80 the viscoelastic material 40 may form the first film 36 having the first thickness 46 (FIG. 2) of from about 0.025 mm to about 0.10 mm.

With continued reference to FIG. 3, the viscoelastic material 40 may be optionally quenched (represented generally by 86) upon exit from the first oven 82 to, for example, further reduce any tackiness of the viscoelastic material 40. For example, the viscoelastic material 40 may be exposed to a comparatively cooler fluid, such as, but not limited to water, air, or combinations thereof

It is to be appreciated that for the aforementioned embodiments including the optional primer layer (not shown), the method 12 may include applying the primer composition (not shown) to the metal substrate 20 (FIG. 2). For example, the primer composition may be applied to the metal substrate 20 as part of the aforementioned continuous coil coating process.

More specifically, as described with reference to FIG. 3, applying the primer composition may include transferring the primer composition in liquid form from at least the first roller 64 to the metal substrate 20, and from at least the second roller 66 to the metal substrate 20 to thereby form the first surface 22 (FIG. 2) and second surface 24 (FIG. 2).

The primer composition may be supplied to the at least first roller 64 and the at least second roller 66 via, for example, the one or more storage vessels 76 disposed in fluid communication with each of the at least first and second rollers 64, 66. For example, each of the at least first and second rollers 64, 66 may pick up the primer composition, rotate in opposite directions 72, 74, and roll the primer composition onto the metal substrate 20 as the metal substrate 20 continuously travels or advances in the processing direction 78.

With continued reference to FIG. 3, after applying the optional primer composition, the method 12 may include curing the primer composition to form the first surface 22 (FIG. 2) and the second surface 24 (FIG. 2). In particular, curing the primer composition may include heating the primer composition to a temperature of from about 150° C. to about 250° C. for from about 1 minute to about 5 minutes. The primer composition may be optionally quenched (represented generally by 86) upon exit from the first oven 82. For example, the primer composition may be exposed to a comparatively cooler fluid, such as, but not limited to water, air, or combinations thereof

In addition, with continued reference to FIG. 3, it is to be appreciated that the method 12 may include pretreating 88 the metal substrate 20 prior to applying the primer composition 18 and/or applying 62 the viscoelastic material 40. For example, the metal substrate 20 may be cleaned to remove grease, lubricants, oil, and dirt from the metal substrate 20, and/or the metal substrate 20 may be chemically treated to promote film adhesion and/or impart corrosion protection. As a non-limiting example, the metal substrate 20 may be pretreated with a pre-cleaning agent such as Parco® Precleaner, commercially available from Henkel Corporation of Rocky Hill, Conn. Optionally, alternatively or additionally, the metal substrate 20 may be pretreated with one or more rinses 90 which may include rinsing the metal substrate 20 with water at elevated temperatures and/or pressures to provide corrosion protection and/or prepare the metal substrate 20 for bonding with the first film 36. Optionally, alternatively or additionally, the metal substrate 20 may be pretreated with one or more cleaning agents such as, but not limited to, Scotch-Brite™, commercially available from 3M of St. Paul, Minn., and/or Parco® 1200, commercially available from Henkel Corporation of Rocky Hill, Conn. Optionally, alternatively or additionally, the metal substrate 20 may be pretreated with one or more protectants such as, but not limited to, Bonderite® from Henkel Corporation of Rocky Hill, Conn.

Referring again to FIG. 3, the method 12 also includes applying 92 the polymer composition 48 to the first film 36 (FIG. 2). The polymer composition 48 may also be applied to the first film 36 as part of the aforementioned continuous coil coating process. As such, the polymer composition 48 may be applied to the first film 36 in liquid form. Alternatively, although not shown, the polymer composition 48 may be applied to the first film 36 in non-liquid form, such as a paste, via, for example, solution coating, extrusion, and/or a calendered film laminating process.

As best shown in FIG. 3, in one non-limiting embodiment, applying 92 the polymer composition 48 may include transferring the polymer composition 48 in liquid form from at least a third roller 68 to the primary surface 42 (FIG. 2), and from at least a fourth roller 70 to the secondary surface 44 (FIG. 2). It is to be appreciated that the at least third roller 68 and the at least fourth roller 70 may each include a plurality of rollers (not shown), and may each be configured as, for example, a three-roller reverse coating apparatus or system.

The polymer composition 48 may be supplied to the at least third roller 68 and the at least fourth roller 70 via, for example, the one or more storage vessels 76 disposed in fluid communication with each of the at least third and fourth rollers 68, 70. For example, each of the at least third and fourth rollers 68, 70 may pick up the polymer composition 48, rotate in opposite directions 72, 74, and roll the polymer composition 48 onto the first film 36 (FIG. 2) as the metal substrate 20 continuously travels or advances in the processing direction 78. In particular, the polymer composition 48 may be transferred at a wet film thickness (not shown) of from about 0.038 mm to about 0.050 mm, e.g., about 0.045 mm. Therefore, in this embodiment, the polymer composition 48 is not applied to the first film 36 via extrusion and/or a calendered film laminating process.

With continued reference to FIG. 3, after applying 92 the polymer composition 48, the method 12 includes curing 94 the polymer composition 48 to form the second film 38 (FIG. 2) to thereby form the composite material 14 (FIG. 1). As best shown in FIG. 2, the resulting second film 38 is disposed on the primary surface 42 and the secondary surface 44. That is, the second film 38 is disposed on both “sides” of the first film 36, i.e., the “top” surface (e.g., the primary surface 42) and “bottom” (e.g., the secondary surface 44) surface of the first film 36. In particular, the resulting second film 38 has the engagement surface 50 spaced opposite the primary surface 42, and the attachment surface 52 spaced opposite the engagement surface 50. In addition, as set forth above, the second elastic modulus of the second film 38 is from about 10 times to about 1,000 times greater than the first elastic modulus of the first film 36. For example, in one embodiment, the second elastic modulus may be from about 100 times to about 1,000 times greater than the first elastic modulus. That is, the second film 38 exhibits excellent stiffness and rigidity.

Referring again to FIG. 3, curing 94 the polymer composition 48 may include heating the polymer composition 48 to a temperature of from about 200° C. to about 260° C. for from about 1 minute to about 5 minutes. More specifically, curing 94 the polymer composition 48 may include first baking the polymer composition 48 in a second oven 84, and subsequently baking the polymer composition 48 again. For curing 94 the polymer composition 48 to form the second film 38, the second oven 84 may have a plurality of heating zones (not shown), e.g., three or four heating zones, configured to sequentially heat the metal substrate 20, the first film 36, and the polymer composition 48.

With continued reference to FIG. 3, in one non-limiting embodiment, the method 12 may include, after applying 92 the polymer composition 48, curing 94 the polymer composition 48 and the viscoelastic material 40. That is, curing 94 the polymer composition 48 may also simultaneously cure the viscoelastic material 40. However, in another non-limiting embodiment of the method 12, the viscoelastic material 40 may be substantially cured before the polymer composition 48 is applied to the first film 36. That is, the viscoelastic material 40 and the polymer composition 48 may separately cure. As such, for the method 12, the viscoelastic material 40 may be partially cured or substantially cured before applying the polymer composition 48 to the first film 36.

Referring to FIG. 3, curing 94 the polymer composition 48 may form the second film 38 having the second thickness 54 (FIG. 2) of greater than about 0.015 mm. That is, curing 94 the polymer composition 48 may form the second film 38 having the second thickness 54 of from about 0.025 mm to about 0.075 mm.

Referring again to FIG. 3, the polymer composition 48 may be optionally quenched (represented generally by 86) upon exit from the second oven 84. For example, the polymer composition 48 may be exposed to a comparatively cooler fluid, such as, but not limited to water, air, or combinations thereof. Further, the metal substrate 20 including the first film 36 (FIG. 2) and second film 38 (FIG. 2) disposed thereon may be rewound into a rewind coil or roll 28 for storage and/or continuous processing. In particular, the metal substrate 20 including the first and second films 36, 38 may be overwound and may include an interleaf (not shown) between successive layers (not shown) of the rewind coil or roll 28.

Referring again to FIG. 3, the method 12 also includes stamping (represented generally at 98) the composite material 14 to thereby form the brake shim 10. That is, the composite material 14, which may include at least the first film 36 and the second film 38 disposed on the metal substrate 20, may be stamped and/or cut to any desired shape and size. As such, the composite material 14 is a stampable product that may be configured according to an end use of the brake shim 10. For example, the composite material 14 may be stamped to form tabs 100 (FIGS. 1) and 90° corners so that the brake shim 10 may have any desired shape.

Further, as described with reference to FIG. 1, the method 12 (FIG. 3) may include, after stamping 98 (FIG. 3) the composite material 14 to form the brake shim 10, adhering 102 the brake shim 10 to the backing plate 16. For example, the method 12 may include sandwiching the adhesive 18 between the brake shim 10 and the backing plate 16. More specifically, the adhesive 18 may be applied to the attachment surface 52 so that the brake shim 10 may attach to the backing plate 16. Since the composite material 14 (FIG. 2) is stampable to any desired shape, the brake shim 10 may adhere or attach to the backing plate 16 in any configuration. Further, the brake shim 10 is flexible, bendable to form 90° corners, and can therefore include tabs 100 (FIG. 1) and components having any shape or size. The brake shim 10 may also be substantially free from delamination and may sufficiently adhere to the backing plate 16.

Referring again to FIG. 3, although not shown, the method 12 may also include applying the anti-friction coating composition to the engagement surface 50 (FIG. 2) and the attachment surface 52 (FIG. 2). In particular, applying the anti-friction coating composition may include transferring the anti-friction coating composition in liquid form from the at least third roller 68 to the engagement surface 50, and from the at least fourth roller 70 to the attachment surface 52. In particular, the anti-friction coating composition may be transferred to the second film 38 at a film thickness (not shown) of from about 0.001 mm to about 0.01 mm, e.g., about 0.013 mm. Alternatively, the anti-friction coating composition may be applied to the second film 38 in non-liquid form. Further, the anti-friction coating composition may not be applied to or disposed on the first film 36 (FIG. 2), but may rather be applied to and disposed on the second film 38, as set forth above.

Although not shown, after applying the anti-friction coating composition, the method 12 may include curing the anti-friction coating composition to form a third film (not shown) disposed on the engagement surface 50 (FIG. 2) and the attachment surface 52 (FIG. 2) and thereby form the composite material 14. That is, the third film may be disposed on both “sides” of the second film 38, i.e., the “top” surface (e.g., the engagement surface 50) and “bottom” surface (e.g., the attachment surface 52) of the second film 38.

Referring again to FIG. 3, curing the anti-friction coating composition may include heating the anti-friction coating composition to from about about 200° C. to about 260° C. for from about 1 minute to about 5 minutes. More specifically, curing the anti-friction coating composition may include baking the anti-friction coating composition in the second oven 84. Curing the anti-friction coating composition may form the optional third film having a third thickness (not shown) of from about 0.001 mm to about 0.01 mm. For example, the third film may have a third thickness of about 0.013 mm.

The anti-friction coating composition may be optionally quenched (represented generally by 86) upon exit from the second oven 84. For example, the anti-friction coating composition may be exposed to a comparatively cooler fluid, such as, but not limited to water, air, or combinations thereof

The aforementioned method 12 (FIG. 3) is cost-effective and forms the brake shim 10 (FIG. 1) having excellent isolation and damping characteristics. For the method 12, each of the first film 36 (FIG. 2) and the second film 38 (FIG. 2) may be applied with a continuous coil coating process rather than a non-continuous operation. In addition, the first film 36 and the second film 38 may be applied with conventional coil coating equipment. That is, conventional coil coating equipment does not require modification for the method 12.

Further, the composite material 14 (FIG. 2) is stampable to any desired shape to thereby form the brake shim 10 (FIG. 1), and the brake shim 10 is robust in harsh operating environments, e.g., at operating temperatures of from about 175° C. to about 205° C., upon exposure to salt spray and/or oil, and upon frequent cycling during repetitive vehicle braking operations. Further, the brake shim 10 is flexible, bendable to form 90° corners, and can therefore include tabs 100 and components having any shape or size. In addition, the brake shim 10 exhibits excellent oil- and wear-resistance, and excellent adhesion of the brake shim 10 to the backing plate 16 (FIG. 1). That is, the brake shim 10 is substantially free from delamination in the aforementioned harsh operating environments. As such, the brake shim 10 is durable and suitable for vehicular and non-vehicular applications requiring excellent noise, vibration, and harshness dissipation and/or damping characteristics.

Without intending to be limited by theory, the second film 38 (FIG. 2) of the brake shim 10 (FIG. 2) may provide the brake shim 10 with excellent stiffness and shear damping properties since the second film 38 may act as a coated constraining layer as opposed to a metal constraining layer (not shown). That is, the second film 38 may complement the first film 36 (FIG. 2) so that the brake shim 10 provides both isolation and shear damping characteristics.

In addition, upon inclusion of the optional additive component, the second film 38 (FIG. 2) may be tailored to exhibit high- or low-friction properties to further aid in noise, vibration, and harshness dissipation. For example, the brake shim 10 may have an overall thickness 96 (FIG. 2) of about 1 mm.

In addition, the second film 38 (FIG. 2) provides scratch- and mar-resistance to the brake shim 10 (FIG. 1). That is, the second film 38 protects the comparatively softer first film 36 (FIG. 2) and provides a comparatively scratch- and mar-resistant outer layer.

In addition, the second film 38 (FIG. 2) prevents the composite material 14 (FIG. 1) from sticking to itself when the composite material 14 is rewound from the sheet form 30 (FIG. 3) to the rewind coil or roll 28 (FIG. 3) before stamping 98 (FIG. 3) to form the brake shim 10 (FIG. 1). That is, the second film 38 eliminates application of a non-stick, release coating composition to the first film 36 (FIG. 2) formed from the viscoelastic material 40 (FIG. 2), which also contributes to a cost-effectiveness of the method 12 based on material reduction.

While the best modes for carrying out the disclosure have been described in detail, those familiar with the art to which this disclosure relates will recognize various alternative designs and embodiments for practicing the disclosure within the scope of the appended claims.

1. A brake shim comprising:
a metal substrate having a first surface and a second surface spaced opposite the first surface;
a first film formed from a viscoelastic material and disposed on the first surface and the second surface, wherein the first film has a first elastic modulus, a primary surface spaced opposite the first surface, and a secondary surface spaced opposite the primary surface; and
a second film formed from a polymer composition including:
a resin component having at least one epoxide functional group; and
a curing agent reactive with the resin component and having at least one amine functional group;
wherein the second film is disposed on the primary surface and the secondary surface and has a second elastic modulus that is from about 10 times to about 1,000 times greater than the first elastic modulus.

2. The brake shim of claim 1, wherein the brake shim includes only one metal substrate.

3. The brake shim of claim 1, wherein the second film has a second thickness of greater than about 0.015 mm.

4. The brake shim of claim 3, wherein the second film thickness is from about 0.025 mm to about 0.075 mm.

5. The brake shim of claim 3, wherein the first film has a first thickness of from about 0.025 mm to about 0.10 mm.

6. The brake shim of claim 3, wherein the metal substrate has a thickness of from about 0.25 mm to about 0.75 mm.

7. The brake shim of claim 3, wherein the second elastic modulus is from about 100 times to about 1,000 times greater than the first elastic modulus.

8. The brake shim of claim 3, wherein the first film is compressible.

9. The brake shim of claim 1, wherein the viscoelastic material includes a nitrile butadiene rubber.

10. The brake shim of claim 9, wherein the polymer composition is an epoxy coating composition.

11. A brake shim comprising:
a metal substrate having a first surface and a second surface spaced opposite the first surface, wherein the metal substrate has a thickness of from about 0.25 mm to about 0.75 mm;
a first film formed from a nitrile butadiene rubber and disposed on the first surface and the second surface, wherein the first film has a first elastic modulus, a primary surface spaced opposite the first surface, and a secondary surface spaced opposite the primary surface;
wherein the first film is compressible and has a first thickness of from about 0.025 mm to about 0.10 mm; and
a second film formed from an epoxy coating composition including:
a resin component having at least one epoxide functional group; and
a curing agent reactive with the resin component and having at least one amine functional group;
wherein the second film is disposed on the primary surface and the secondary surface, and has an engagement surface spaced opposite the primary surface and an attachment surface spaced opposite the engagement surface;
wherein the second film has a second elastic modulus that is from about 10 times to about 1,000 times greater than the first elastic modulus;
wherein the second film has a second thickness of from about 0.025 mm to about 0.075 mm.

12. A method of forming a brake shim, the method comprising:
applying a viscoelastic material to a metal substrate, wherein the metal substrate has a first surface and a second surface spaced opposite the first surface;
after applying the viscoelastic material, at least partially curing the viscoelastic material to form a first film disposed on the first surface and the second surface, wherein the first film has a first elastic modulus, a primary surface spaced opposite the first surface, and a secondary surface spaced opposite the primary surface;
applying a polymer composition to the first film, wherein the polymer composition includes:
a resin component having at least one epoxide functional group; and
a curing agent reactive with the resin component and having at least one amine functional group; and
after applying the polymer composition, curing the polymer composition to form a second film disposed on the primary surface and the secondary surface and having a second elastic modulus that is from about 10 times to about 1,000 times greater than the first elastic modulus to thereby form a composite material; and
stamping the composite material to thereby form the brake shim.

13. The method of claim 12, wherein curing the polymer composition forms the second film having a second thickness of greater than about 0.015 mm.

14. The method of claim 13, wherein at least partially curing the viscoelastic material forms the first film having a first thickness of from about 0.025 mm to about 0.10 mm.

15. The method of claim 14, wherein curing the polymer composition forms the second film having the second thickness of from about 0.025 mm to about 0.075 mm.

16. The method of claim 12, wherein applying the viscoelastic material includes transferring the viscoelastic material in liquid form from at least a first roller to the first surface, and from at least a second roller to the second surface, wherein the at least first roller is rotatable in a first direction and the at least second roller is rotatable in a second direction that is opposite the first direction.

17. The method of claim 16, wherein at least partially curing the viscoelastic material includes increasing a temperature of the viscoelastic material to from about 100° C. to about 260° C. for from about 1 minute to about 5 minutes.

18. The method of claim 12, further including, after applying the polymer composition, curing the polymer composition and the viscoelastic material.

19. The method of claim 12, wherein applying the polymer composition includes transferring the polymer composition in liquid form from at least a first roller to the primary surface, and from at least a second roller to the secondary surface, wherein the at least first roller is rotatable in a first direction and the at least second roller is rotatable in a second direction that it opposite the first direction.

20. The method of claim 19, wherein curing the polymer composition includes heating the polymer composition to a temperature of from about 200° C. to about 260° C. for from about 1 minute to about 5 minutes.
